(19) United States
(12) Patent Application Publication
(10) Pub. No.: US 2004/0205668 A1
(43) Pub. Date: Oct. 14, 2004

(54) Native markup language code size reduction

(76) Inventor: Donald Eastlake III, Milford, MA (US)

Correspondence Address: Larson & Associates, P.C., 221 East Church Street, Frederick, MD, 21701-5405, US

(21) Appl. No.: 10/136,094

(22) Filed: Apr. 30, 2002

(51) Int. Cl. G06F 17/21; G06F 17/24

(52) U.S. Cl. 715/531; 715/534

(57) ABSTRACT

A computer-assisted method of reducing the size of a Macro Enabled Markup Language document such as XML is provided in which a segment of text is identified (112) within the document that is used repeatedly. This segment of text can be reduced by creation of a macro such as an XML Entity declaration. Thus, an Entity declaration is created (116) establishing a shorthand name for the segment of text. The Macro Enabled Markup Language Entity declaration is inserted (120) into the document at a location preceding the first use of the segment of text, and the shorthand name is substituted (124) throughout the document in place of the segment of text.

### FIELD OF THE INVENTION

This invention relates generally to the field of code size reduction. More particularly, this invention relates to reduction of code size in languages such as XML (eXtensible Markup Language) and other macro enabled markup languages using Entity declarations or similar functions.

### BACKGROUND OF THE INVENTION

XML is becoming increasingly popular as a flexible way to handle and exchange data between businesses, in files and on web pages. Unfortunately, XML is a very verbose language and therefore often takes more data to transmit than other languages. This can be a substantial disadvantage in low bandwidth applications such as, for example, wireless communication.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a flow chart describing a process for reducing the size of an XML document consistent with certain embodiments of the present invention.

FIG. 2 is a flow chart of a search routine consistent with an exemplary XML embodiments of the present invention.

FIG. 3 is a detailed flow chart of routine 250 referenced in FIG. 2.

FIG. 4 is a block diagram of a computer system suitable for use in implementing a process consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

Entity declarations are used in the XML (eXtensible Markup Language) language to create associations between a name and a segment of content. This permits the use of a name as shorthand for a longer segment of content. For example, consider the following Entity declaration as it might appear within a segment of XML code:

<!ENTITY JCD “John C. Doe”>

This Entity declaration defines that “JCD” is to be used as a shorthand notation for the text string “John C. Doe”. Thus, in order for the full text string to be inserted in any place within an XML document, the programmer need only insert the shorthand text “&JCD” and “John C. Doe” will be substituted in its place. Thus, the Entity declaration defines JCD as the abbreviation for the longer text string “John C. Doe”.

This is a simple example of an internal Entity declaration. External Entity declarations also exist and can be used to substitute a file for the shorthand name. Such declarations are useful in creating shortcuts for frequently typed text or text that might be subject to change.

In accordance with certain embodiments of the present invention, Entity declarations are used by a computer implemented process to reduce the size of an XML document to thereby reduce transmission time, storage space and/or bandwidth. Those skilled in the art will understand that the present invention is described in terms of XML due to the currently growing popularity of this language. However, XML is but one of a family of languages known generically as SGML (Standard General Markup Language). Any current or future language that utilizes an Entity declaration or similar macro facility can equally and equivalently be used in conjunction with the present invention without limitation. For purposes of this document, the term “Macro Enabled Markup Language” will be used to designate such languages, and “Entity declarations” will be intended to embrace the macro facility of the language without regard for whether or not the language's syntax specifically uses an “Entity” declaration per se. That said, the exemplary embodiments described herein with use XML as an illustrative example, which should not be considered limiting.

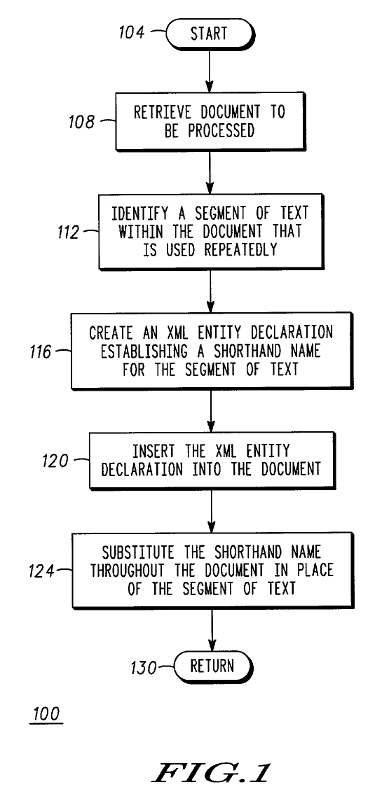

Turning now to FIG. 1, a flow chart 100 depicts one process consistent with certain embodiments of the present invention starting at 104. At 108 the XML document is retrieved (if necessary) for processing. At 112, the document is processed by a search routine that identifies segments of text within the document that are used repeatedly, and therefore can be replaced with an Entity declaration defining shorthand names for the segments of text. At 116, Entity declarations are created to establish shorthand names for the segments of text identified at 112. Once the Entity declarations are created at 116, they are inserted at an appropriate location within the document at 120, (i.e., in advance of all uses of the corresponding segment of text). These shorthand names are then used to replace the segments of text at 124 and thus reduce the size of the document. The routine ends at this point and further action such as saving and/or printing the revised document and/or transmitting and/or otherwise serializing the document can be carried out on the size-reduced document. Once the document is processed as described, any XML compliant recipient of the document will interpret the document the same as the original document by making the substitutions defined in the Entity declarations.

Thus, in accord with the above description, a computer assisted method of reducing the size of a Macro Enabled Markup Language document (such as an XML document) consistent with certain embodiments of the present invention identifies a segment of text within the document that is used repeatedly; creates a Macro Enabled Markup Language Entity declaration establishing a shorthand name for the segment of text; inserts the Macro Enabled Markup Language Entity declaration into the document; and substitutes the shorthand name throughout the document in place of the segment of text to produce a compressed document.

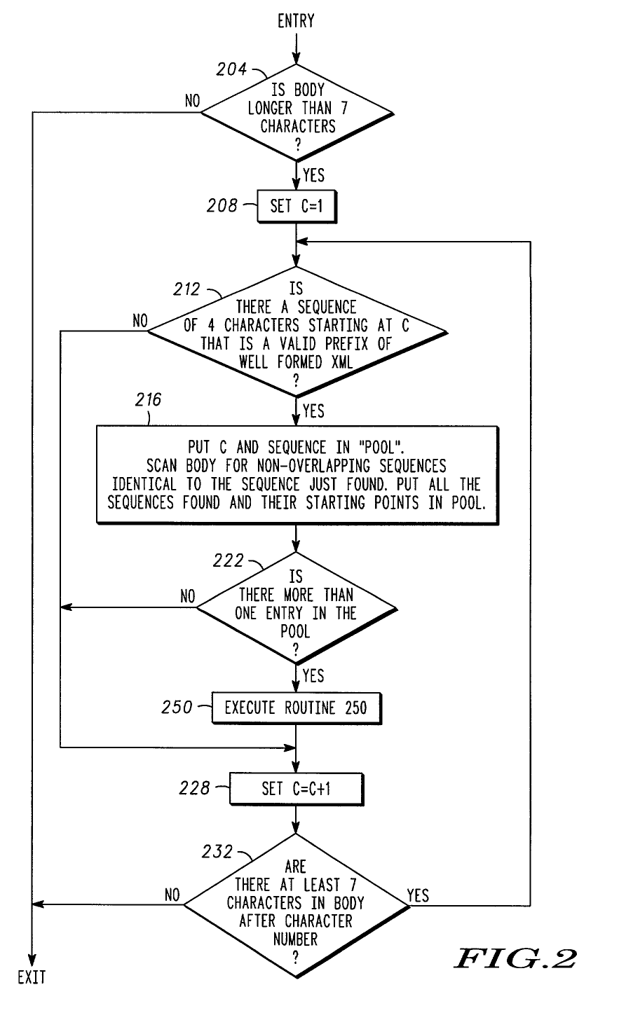

FIG. 2 describes a process for finding appropriate sequences in an XML document that can be reduced in size using Entity declarations. The algorithm works as follows: An XML document, by definition, has declarations at the start and then a body. Frequently, the largest part of the declarations (and the only part of interest for purposes of this invention) is the DTD or Document Type Declaration. So, generally the XML document is arranged as:

. . . DTD . . . Body

To optimize the body, an algorithm is run over the body looking for repeated parts which can be replaced by use of Entity declarations that create abbreviations using the Entity feature. When an appropriate part that is repeated is found, it can be replaced at each occurrence with an “Entity reference” (the abbreviation) and then add an “Entity declaration” to the DTD. The minimum length of an Entity reference in current versions of XML is three characters. Thus, it only saves characters to create a shorthand if the segment being replaced with the shorthand is at least four characters long and the replacement will result in a net reduction in the document size. After the Body is optimized, then the document is then arranged as:

. . . DTD+additionalENTITYs . . . Optimized-Body

The same process can be used on the DTD+additionalENTITYs that was used on the Body except that, due to quirks of XML, these sorts of “abbreviations” in the DTD are called “parameter entities”, and they have to be defined before they are used. So they are inserted near the front of the DTD. The fully optimized form would be arranged as:

. . . DTD (i.e., parameter-entities followed by optimized oldDTD+additionalENTITYs) . . . Optimized-Body

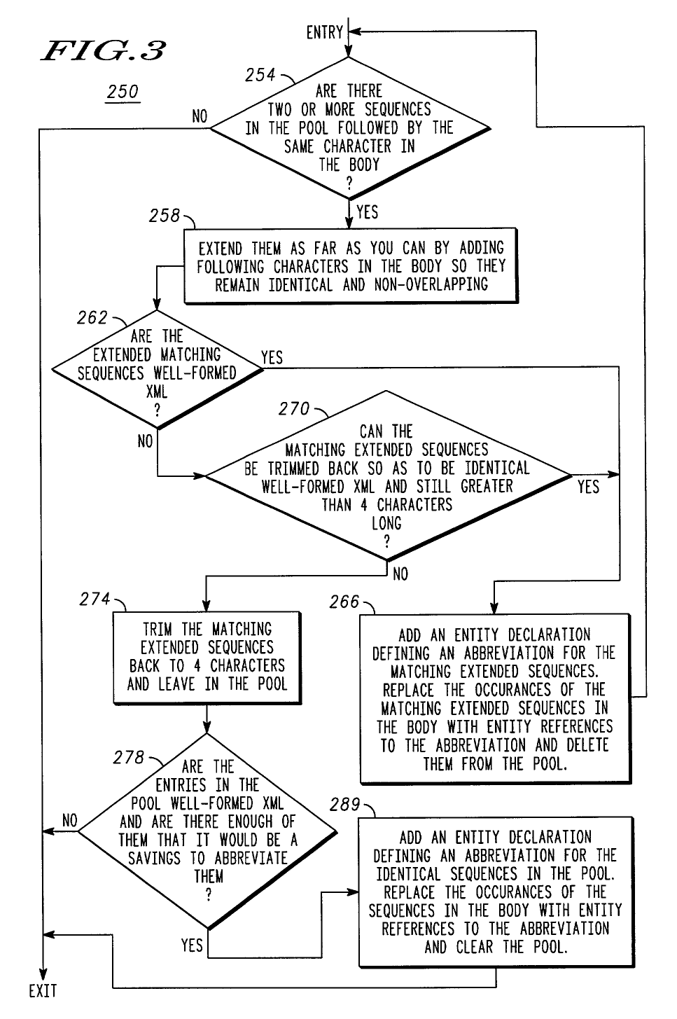

FIG. 2 is a flow chart of an exemplary process that can be used in an XML environment consistent with embodiments of the present invention. The process is entered at 204 where a determination is made as to whether or not the body of the XML document is greater in length than seven characters because a shorter document could not have at least two strings of four characters to abbreviate. If it is not, there will be no benefit to attempts to compress the body according to the present arrangement and the process exits. (This minimum length may vary if this technique is used with other Macro Enabled Markup Languages.) Otherwise, a variable C, which serves as a character counter for the document, is initialized to 1 at 208 (i.e., at the beginning of the Body). The Body is then searched at 212 to determine if there is a sequence of four characters starting at location C in the document that is a valid prefix of a well formed line of XML. A segment of XML is considered “well formed” if contains one or more elements and meets all the well-formed constraints given in the XML 1.0 Recommendation. If so, at 216 C and the sequence starting at C are placed in a pool and the body of the document is scanned for non-overlapping sequences identical to the sequence stored in the pool. Whenever one is found, it is also placed in the pool along with its starting point. If more than one is found at 222, the routine 250 of FIG. 3 is executed. C is then incremented at 228. If there are less than seven characters in the body at 232 after the current character number C, the routine exits. If there are more than seven characters at 232, control returns to 212 to iterate the routine. If there are not more than one entry in the pool at 222, routine 250 is jumped and the counter C is incremented at 228.

The routine 250 of FIG. 3 is entered at decision 254 where a determination is made as to whether or not there are two or more sequences in the pool followed by the same character in the body. If not, the routine exits. If so, control passes to 256 where the routine extends the sequences as far as possible by examining the body of the document starting at the end of each sequence character by character to determine how far the sequence is a duplicate and non-overlapping. If they are well formed XML sequences at 262, an Entity declaration is created at 266 defining an abbreviation for the matching extended sequences and each occurrence of the sequence in the body of the document is replaced by the abbreviation. The sequence is then deleted from the pool and control returns to the entry point.

In the event the extended matching sequences are not well formed XML at 262, control passes to 270 to determine if the matching extended sequences can be trimmed back to make them well formed XML and still greater than four characters long. If so, the trimming is carried out and control passes to 266 as before. If not, the matching extended sequences are trimmed back to four characters and they are left in the pool at 274. Control then passes to 278 where it is determined whether the entries in the pool are well formed XML and whether there are enough of them to create a savings if they are abbreviated. If not, the routine exits at this point. If so, control passes to 284 where an entity declaration is added defining an abbreviation for the identical sequences in the pool and the occurrences of those sequences are replaced in the body of the document with the abbreviations and the pool is cleared. The routine then returns.

The above process, as previously mentioned, is described in terms of an XML specific process that may be directly applicable to other SGML languages and generally to other Macro Enabled Markup Languages. However, those skilled in the art will be able to translate the above process into any suitable Macro Enabled Markup Language by appropriate conversion of the constants in the above process. This is but one exemplary algorithm that can be used to find repeating strings that can be compacted using the Entity declarations according to embodiments of the present invention. Many other suitable algorithms can also be devised without departing from the present invention so long as they suitably identify repeated strings of characters that can be reduced by use of the Entity declaration.

One advantage of the process described above is that support for such internal subsets, embedded within a document prefix, is required for standard conformant XML processors. In contrast, support for external DTD information is not required and even when supported requires an additional retrieval.

The present process can, of course, be used in conjunction with other techniques for compression of files such as the WAP forum's binary XML or by running general data compression algorithms such as Limpel-Ziv compression. Of course, these additional compression measures may require non-standard modifications to the receiver and sender of the compressed XML.

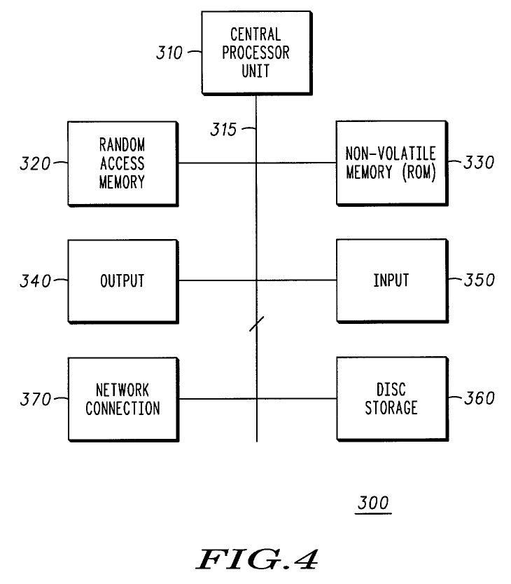

The processes previously described can be carried out on a programmed general-purpose computer system, for example, such as the exemplary computer system 300 depicted in FIG. 4. Computer system 300 has a central processor unit (CPU) 310 with an associated bus 315 used to connect the central processor unit 310 to Random Access Memory 320 and/or Non-Volatile Memory 330 in a known manner. An output mechanism at 340 may be provided in order to display and/or print output for the computer user. Similarly, input devices such as keyboard and mouse 350 may be provided for the input of information by the computer user. Computer 300 also may have disc storage 360 for storing large amounts of information including, but not limited to, program files and data files. Computer system 300 may be is coupled to a local area network (LAN) and/or wide area network (WAN) and/or the Internet using a network connection 370 such as an Ethernet adapter coupling computer system 300, possibly through a fire wall.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A computer assisted method of reducing the size of a Macro Enabled Markup Language document, comprising:
identifying a segment of text within the document that is used repeatedly;
creating a Macro Enabled Markup Language Entity declaration establishing a shorthand name for the segment of text;
inserting the Macro Enabled Markup Language Entity declaration into the document; and
substituting the shorthand name throughout the document in place of the segment of text to produce a compressed document.

2. The method according to claim 1, wherein the Entity declaration is inserted into the document at a location preceding the first use of the segment of text.

3. The method according to claim 1, wherein the Macro Enabled Markup Language comprises a Standard General Markup Language.

4. The method according to claim 1, wherein the Macro Enabled Markup Language comprises XML.

5. The method according to claim 1, wherein the segment of text is at least four characters in length.

6. The method according to claim 1, wherein the identifying comprises scanning a Body portion of the Document for identical non-overlapping sequences of characters.

7. The method according to claim 6, wherein the sequences of characters are well formed.

8. The method according to claim 6, wherein a sequence of identical non-overlapping characters is not well formed and further comprising trimming the sequence in length until the sequence is well formed.

9. The method according to claim 1, followed by:
identifying a segment of text within the compressed document that is used repeatedly;
creating a Macro Enabled Markup Language Parameter Entity declaration establishing a shorthand name for the segment of text;
inserting the Macro Enabled Markup Language Parameter Entity declaration into the document at a location prior to the first use shorthand name; and
substituting the shorthand name throughout the compressed document in place of the segment of text to produce an optimized compressed document.

10. The method according to claim 9, further comprising transmitting the optimized compressed document to a recipient.

11. The method according to claim 1, further comprising transmitting the compressed document to a recipient.

12. A computer assisted method of reducing the size of an XML document, comprising:
identifying a segment of text within the document that is used repeatedly;
creating an XML Entity declaration establishing a shorthand name for the segment of text;
inserting the XML Entity declaration into the document; and
substituting the shorthand name throughout the document in place of the segment of text to produce a compressed document.

13. The method according to claim 12, wherein the Entity declaration is inserted into the document at a location preceding the first use of the segment of text.

14. The method according to claim 12, wherein the segment of text is at least four characters in length.

15. The method according to claim 12, wherein the identifying comprises scanning a Body portion of the Document for identical non-overlapping sequences of characters.

16. The method according to claim 15, wherein the sequences of characters are well formed.

17. The method according to claim 15, wherein a sequence of identical non-overlapping characters is not well formed and further comprising trimming the sequence in length until the sequence is well formed.

18. The method according to claim 12, followed by:
identifying a segment of text within the compressed document that is used repeatedly;
creating an XML Parameter Entity declaration establishing a shorthand name for the segment of text;
inserting the XML Parameter Entity declaration into the document at a location prior to the first use shorthand name; and
substituting the shorthand name throughout the compressed document in place of the segment of text to produce an optimized compressed document.

19. The method according to claim 18, further comprising transmitting the optimized compressed document to a recipient.

20. The method according to claim 10, further comprising transmitting the compressed document to a recipient.

21. A computer assisted method of reducing the size of an XML document, comprising:
identifying a segment of text at least four characters in length within the document that is used repeatedly by scanning a Body portion of the Document for identical non-overlapping sequences of characters that constitute well formed XML;
creating an XML Entity declaration establishing a shorthand name for the segment of text;
inserting the XML Entity declaration into the document at a location preceding the first use of the segment of text;
substituting the shorthand name throughout the document in place of the segment of text to produce a compressed document;
processing the compressed document by:
identifying a segment of text within the compressed document that is used repeatedly;
creating an XML Parameter Entity declaration establishing a shorthand name for the segment of text;
inserting the XML Parameter Entity declaration into the document at a location prior to the first use shorthand name;
substituting the shorthand name throughout the compressed document in place of the segment of text to produce an optimized compressed document; and
transmitting the optimized compressed document to a recipient.
